(19) United States
(12) Patent Application Publication
(10) Pub. No.: US 2007/0195370 A1
(43) Pub. Date: Aug. 23, 2007

(54) Workflow system, server device, and processing method of workflow system

(76) Inventors: Satoshi Suga, Kanagawa (JP); Toshiyuki Furuta, Kanagawa (JP); Tomohiko Beppu, Kanagawa (JP); Sadao Takahashi, Kanagawa (JP); Hirofumi Horikawa, Kanagawa (JP); Yuuta Hamada, Tokyo (JP)

Correspondence Address: COOPER & DUNHAM, LLP, 1185 AVENUE OF THE AMERICAS, NEW YORK, NY, 10036, US

(21) Appl. No.: 11/526,166

(22) Filed: Sep. 22, 2006

(30) Foreign Application Priority Data
Sep. 26, 2005 (JP) 2005-278305

(51) Int. Cl. G06K 15/00

(52) U.S. Cl. 358/1.18; 358/1.2

(57) ABSTRACT

A workflow system for performing a process according to information input to an electronic form from an input screen displaying the electronic form, and inputting handwritten information of a corresponding paper form to the electronic form is disclosed. Based on screen formation data used for forming the input screen, paper layout information defining the paper form corresponding to the input screen is generated. The paper form is printed based on the paper layout information together with a form ID identifying the electronic form. An image of the printed paper form to which handwritten information is added is input. The handwritten information and the form ID are extracted from the image of the paper form input, converted to electronic handwritten information, and input to the electronic form corresponding to the extracted form ID.

### BACKGROUND OF THE INVENTION

1. Field of the Invention

The present invention relates generally to workflow systems, server devices, and processing methods of workflow systems, and more particularly to a workflow system, a server device, and a processing method of a workflow system in which an electronic form used in processes of a workflow can be printed onto paper, and the printed-out paper form can be used for the processes of the workflow.

2. Description of the Related Art

A workflow system is used for centrally managing an electronic file, which is shared by plural departments and persons in sequential processes of an operational flow (hereinafter, a workflow using only an electronic file is referred to as an “electronic workflow”).

FIGS. 1A, 1B are schematic diagrams of examples of conventional electronic workflow systems. The electronic workflow system shown in FIG. 1A includes a server device 101, a printer 104, a user interface 102, a disk device 105 for storing files, and a client device 107 connected via a network 106. The printer 104 can be a multifunctional peripheral that also functions as a scanner or a facsimile machine.

The user interface 102 includes a display unit 102a and a keyboard unit 102b, which are used by users and administrators to input operations. The network 106 can be a LAN, the Internet, or an intranet. The client device 107 communicates with the server device 101 through the network 106, and requests the server device 101 to print electronic files or to perform workflow processes.

The server device 101 includes a user interface (I/F) control unit 108 for controlling the user interface 102, a disk interface (I/F) control unit 109 for controlling the disk device 105, a printer interface (I/F) control unit 112, and a network interface (I/F) control unit 113 for controlling communication via the network 106.

Information input to the user I/F control unit 108 is transmitted to a workflow process unit 110, and stored in the disk device 105 via the disk I/F control unit 109. For example, when a business form is designed in a workflow, an electronic file of the designed form is stored in the disk device 105. When a request to print the form is received from the user interface 102, an image is generated based on the form stored in the disk device 105 in a print process unit 111, and is printed at the printer 104 via the printer I/F control unit 112. When a user or a client modifies or adds content to the form, the workflow process unit 110 acquires data input from the keyboard unit 102b or from the client device 107 via the network 106, and saves the data in the disk device 105 via the disk I/F control unit 109, or executes a workflow process using the data.

The printer 104 can be connected to the server device 101 via the network 106, as shown in FIG. 1B. A network printer 202 shown in FIG. 1B connected via the network I/F control unit 113 corresponds to the printer 104 shown in FIG. 1A.

When performing examination/authorization operations in the electronic workflow systems shown in FIGS. 1A, 1B, processes such as issuing a form, executing examination/authorization, and reviewing the flow status are performed by electronic input. Occasionally, electronic forms are printed at the printer 104 for purposes such as confirming the design of the form or storing the print-out, but not for purposes pertaining to the main workflow.

For example, there is a technology for reading a paper form that has been created in the past by using a scanner, and acquiring the form structure from image data (see, for example, Patent Document 1). According to this technology, a paper form available from the past is used for facilitating the task of creating an electronic form to be used in an electronic workflow; however, this technology is not intended for using a paper form in processes of the workflow.

Processes of a workflow can be executed with more convenience if an electronic file and printed matter are both used in combination in the workflow. One approach is to print an electronic form, handwrite contents in the printed form, and convert the handwritten contents into electronic input (see, for example, Patent Document 2). Specifically, a predetermined World Wide Web (hereinafter, “WWW”) page is printed onto paper, the printed-out paper is placed on a tablet, and a user handwrites content on the paper with a pen. The tablet calculates coordinates of the tip of the pen, so that handwritten content can be detected via the tablet.

Patent Document 1: Japanese Laid-Open Patent Application No. H9-6863

Patent Document 2: Japanese Laid-Open Patent Application No. 2005-11045

However, the technology disclosed in Patent Document 2 is for inputting contents to a particular WWW page from a print-out thereof, but not for associating an arbitrary electronic form with a print-out thereof, or associating content input to the print-out with the arbitrary electronic form. Patent Document 2 discloses a method of inputting content to a WWW page, but does not disclose methods of inputting content to and handling an arbitrary paper form.

### SUMMARY OF THE INVENTION

The present invention provides a workflow system, a server device, and a processing method of a workflow system in which one or more of the above-described disadvantages is eliminated.

A preferred embodiment of the present invention provides a workflow system, a server device, and a processing method of a workflow system, in which an electronic form used for electronic processes in a workflow can be printed onto paper, and the print-out paper form can be used for the electronic processes of the workflow.

An embodiment of the present invention provides a workflow system for performing a predetermined process according to information input to an electronic form from an input screen displaying the electronic form, the input screen being formed based on screen formation data, and inputting handwritten information of a corresponding paper form to the electronic form, the workflow system including a paper form managing unit configured to generate, based on the screen formation data, paper layout information defining a paper form corresponding to the input screen; a print process unit configured to print the paper form based on the paper layout information together with a form ID identifying the electronic form; an image input device configured to input an image of the printed paper form to which handwritten information is added; and a paper flow process unit configured to extract the handwritten information from the image of the paper form input by the image input device, together with the form ID identifying the electronic form; wherein the extracted handwritten information is converted to electronic handwritten information, and the electronic handwritten information is input to the electronic form corresponding to the form ID extracted by the paper flow process unit.

According to one embodiment of the present invention, a workflow system, a server device, and a processing method of a workflow system can be provided, in which an electronic form used in processes of a workflow can be printed onto paper, and the print-out paper form can be used for the processes of the workflow.

### BRIEF DESCRIPTION OF THE DRAWINGS

Other objects, features and advantages of the present invention will become more apparent from the following detailed description when read in conjunction with the accompanying drawings, in which:

FIGS. 1A, 1B are schematic diagrams of examples of conventional electronic workflow systems;

FIG. 2A is a schematic diagram of processes in a workflow system according to an embodiment of the present invention;

FIG. 2B is an example of a paper form P with handwritten contents;

FIG. 3 is a functional block diagram of a workflow system according an embodiment of the present invention;

FIG. 4 is a block diagram of a hardware configuration of a server device shown in FIG. 3;

FIG. 5 is one example of a screen formation data table;

FIG. 6 is one example of an input data type table;

FIG. 7 is one example of an electronic input screen displayed on a computer;

FIG. 8 is a form structure described in XML;

FIGS. 9A, 9B are operation screens for a form creating program;

FIG. 10 is a flowchart of a process performed by a paper flow process unit for creating a paper form;

FIG. 11 is one example of a paper layout table;

FIG. 12 is one example of an access management table;

FIGS. 13A, 13B, 13C, 13D are route diagrams of workflow processes controlled according to access rights;

FIG. 14 is a flowchart of a process performed by the paper flow process unit for printing the paper form;

FIG. 15 is a table showing information included in a paper form ID;

FIG. 16 is an example of a printed paper form;

FIG. 17 is a flowchart of a workflow process operation performed by the paper flow process unit;

FIG. 18 is an example of a paper form with handwritten contents;

FIG. 19 is a functional block diagram of another embodiment of the workflow system;

FIG. 20 is a functional block diagram of yet another embodiment of the workflow system; and

FIG. 21 is a functional block diagram of yet another embodiment of the workflow system.

### DETAILED DESCRIPTION OF THE PREFERRED EMBODIMENTS

A description is given, with reference to the accompanying drawings, of an embodiment of the present invention. A workflow system processing method according the present invention is used in an embodiment of a workflow system according to the present invention; therefore, an embodiment of the workflow system processing method according the present invention is described together with the embodiment of the workflow system according to the present invention.

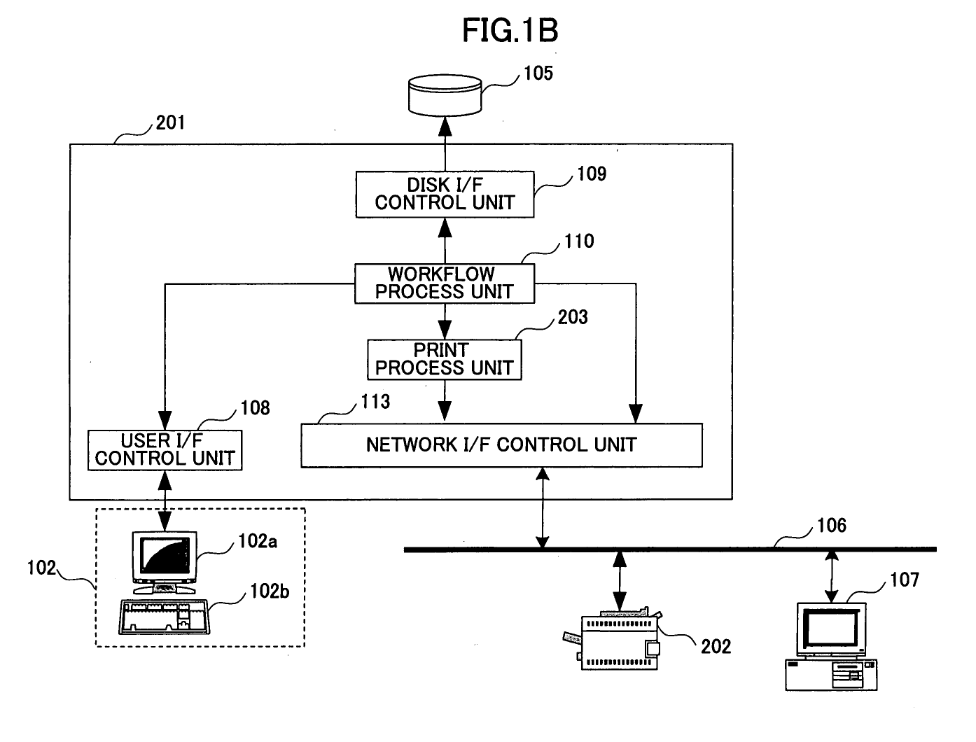

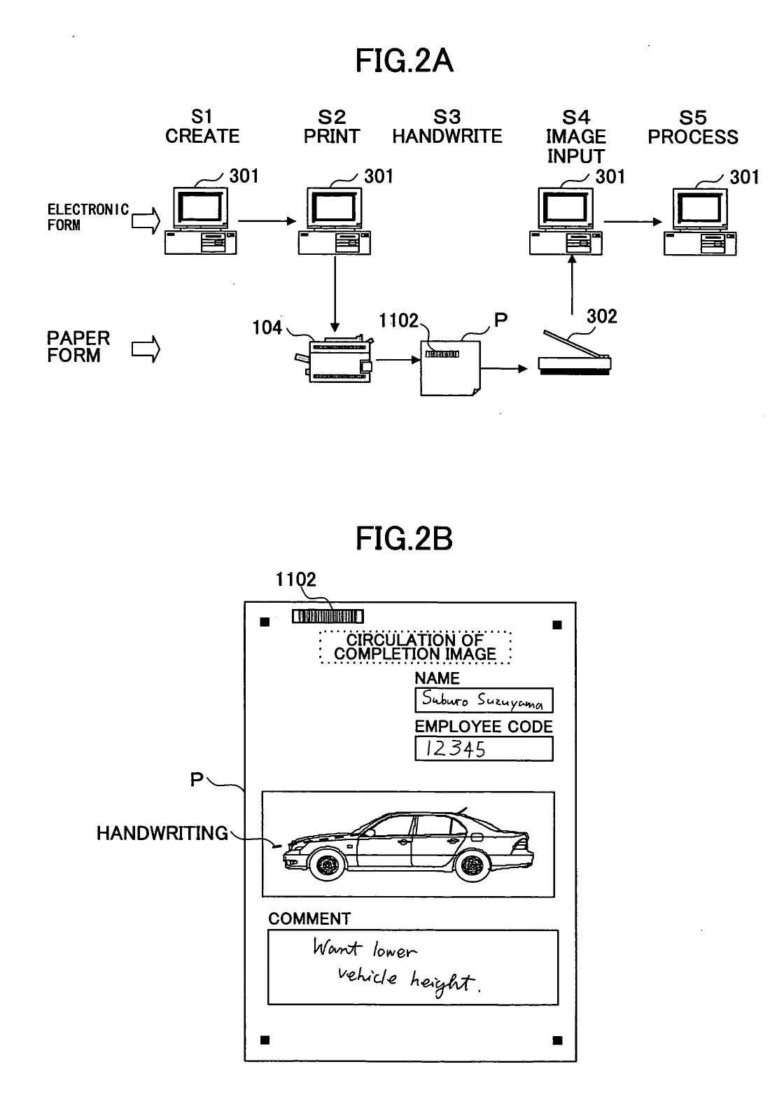

FIG. 2A is a schematic diagram of processes in a workflow system. Processes shown in the upper row are performed on an electronic form; processes shown in the lower row are performed on a paper print-out of the electronic form. First, an administrator creates or registers a form by using a server device 301 (step S1). In a case where only an electronic file is used in the electronic workflow, the created electronic form is transmitted to the client device 107 of a user (may be plural users). If the user inputs content to the received form at the client device 107, the updated form is transmitted to the server device 301, and the server device 301 performs predetermined processes in accordance with the contents of the form (step S5).

In an embodiment according to the present invention, the created electronic form is printed onto paper (step S2), the user handwrites content onto a paper form P printed onto paper (step S3), and the paper form P is read by a scanner 302, etc. (step S4). The server device 301 digitizes the contents read by the scanner, so that the form can be processed electronically in subsequent processes of the electronic workflow. A paper form ID 1102 is printed on the paper form P for identification; therefore, by decoding the paper form ID 1102, the original electronic form can be identified. Accordingly, the hand written contents of the paper form P can be input to the original electronic form.

FIG. 2B is an example of the paper form P with handwritten contents. The paper form P shown in FIG. 2B is a “circulation of completion image”, and includes a drawing of an automobile. A person can manually draw design improvements directly into the drawing. The design improvement is indicated by a dashed line in FIG. 2B. Comments can be written in a comment field to supplement the drawing.

Accordingly, in the workflow according to an embodiment of the present invention, both an electronic file and a paper form can be used in combination, or only a paper form can be used. Therefore, in a case where a workflow process can be performed more efficiently by using paper, such as circulation of a product design, it is possible to enhance effectiveness.

Hereinafter, the person who creates and prepares a form is referred to as an administrator, and the person who handwrites content in the form is referred to as a user; however, the administrator and the user can be the same person.

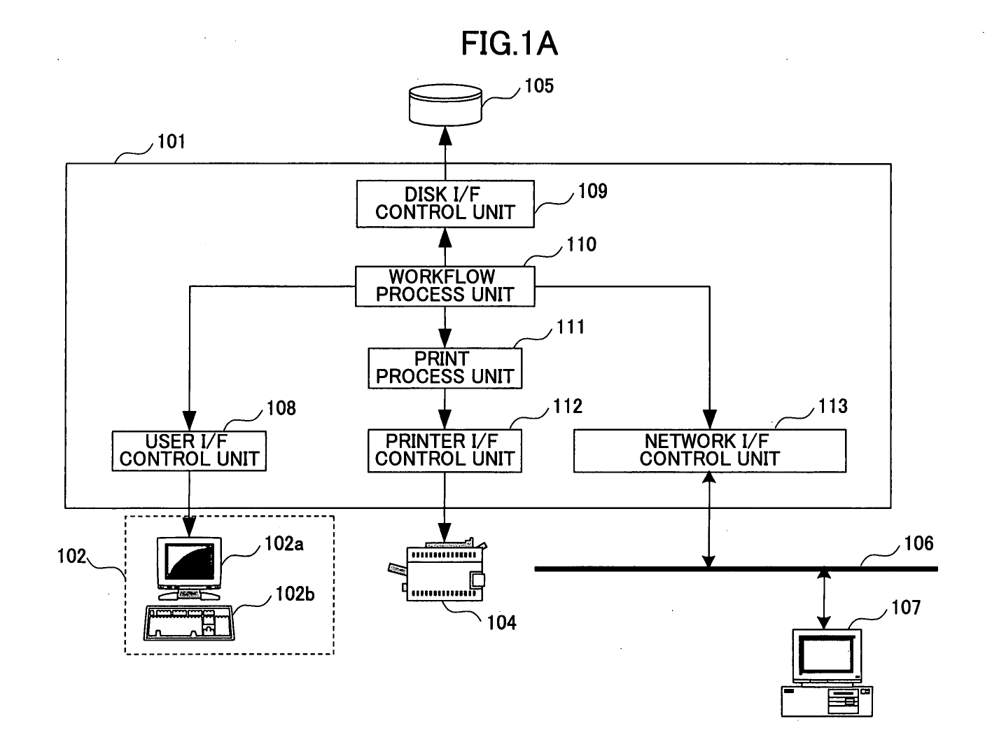

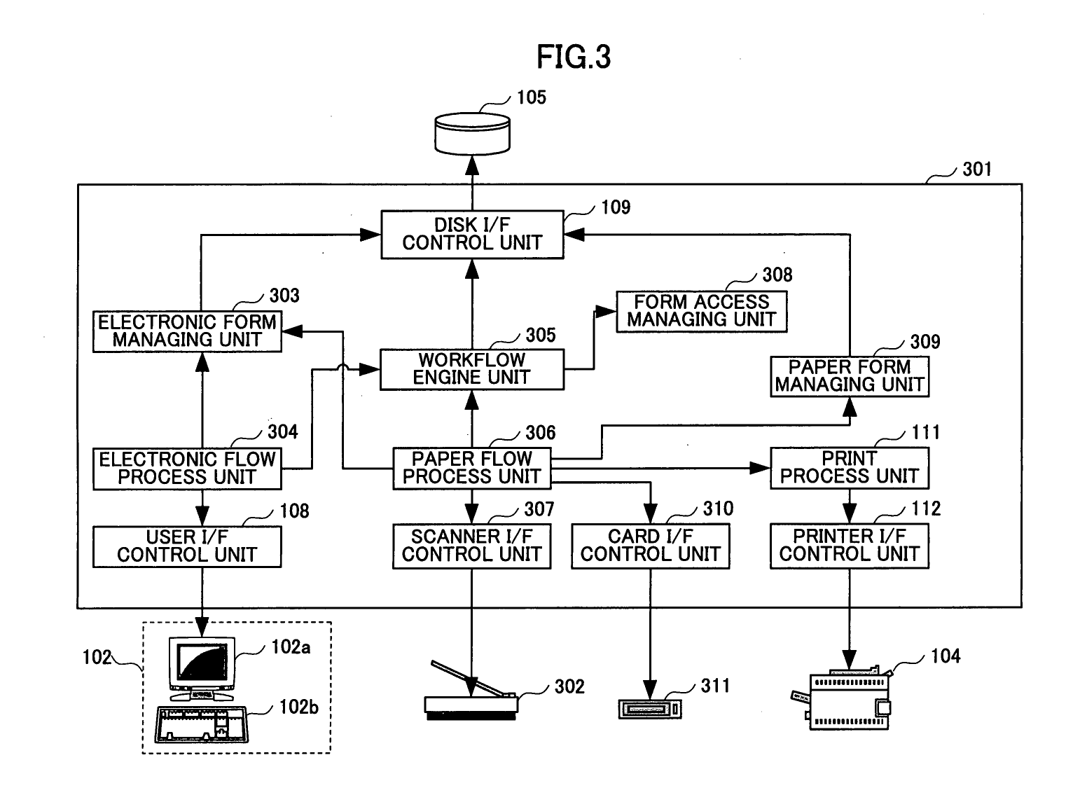

FIG. 3 is a functional block diagram of a workflow system according to an embodiment of the present invention. In FIG. 3, elements corresponding to those in FIGS. 1A, 1B, 2 are denoted by the same reference numbers. The workflow system shown in FIG. 3 includes the server device 301, the printer 104, the user interface 102, the disk device 105 for storing files, the scanner 302 for reading images, and an IC card reader 311 for reading from/writing in an IC card.

The user interface 102 includes the display unit 102a and the keyboard unit 102b, which is used by users and administrators to input operations. The server device 301 includes the user I/F control unit 108 for controlling the user interface 102, the disk I/F control unit 109 for controlling the disk device 105, the printer I/F control unit 112, a scanner interface (I/F) control unit 307 for controlling the scanner 302, and a card interface (I/F) control unit 310 for controlling the IC card reader 311.

The user I/F control unit 108 is connected to an electronic flow process unit 304, and the electronic flow process unit 304 is connected to an electronic form managing unit 303 and a workflow engine unit 305. The scanner I/F control unit 307 is connected to a paper flow process unit 306, and the paper flow process unit 306 is connected to the workflow engine unit 305, the electronic form managing unit 303, the card I/F control unit 310, the print process unit 111, and a paper form managing unit 309. The workflow engine unit 305 is connected to the disk I/F control unit 109 and a form access managing unit 308, and the paper form managing unit 309 is connected to the disk I/F control unit 109.

The server 301 controls input from/output to a user at the display unit 102a and the keyboard unit 102b of the user interface 102, via the user I/F control unit 108.

Input from the user is transmitted to the workflow engine unit 305, and design data of an electronic form format are stored in the disk device 105 via the disk I/F control unit 109. The design data can be created at the user interface 102, or read from a drive device (not shown) of the user interface 102.

The paper form managing unit 309 creates a paper form layout for printing a paper form by using the design data of the electronic form format, and the paper form layout is stored in the disk device 105 via the disk I/F control unit 109. When a request is received from a user, an image is generated based on the stored paper form design data at the print process unit 111, and printed at the printer 104 via the printer I/F control unit 112.

When a data item is input by a user from the keyboard unit 102b, the electronic flow process unit 304 processes the input data item, and transmits the processed input data item to the workflow engine unit 305, thereby executing a workflow. Similarly, when a scanned data item is input by a user from the scanner 302 via the scanner I/F control unit 307, the paper flow process unit 306 processes the scanned data item, and transmits the processed scanned data item to the workflow engine unit 305, thereby executing a workflow. When an IC card is inserted into the IC card reader 311, the card I/F control unit 310 authenticates the user.

The form access managing unit 308 manages access rights for each user; access rights are given to users to access processes such as printing, paper flow processes, electronic flow processes, etc. Each user is identified by a user ID stored in the IC card of the user.

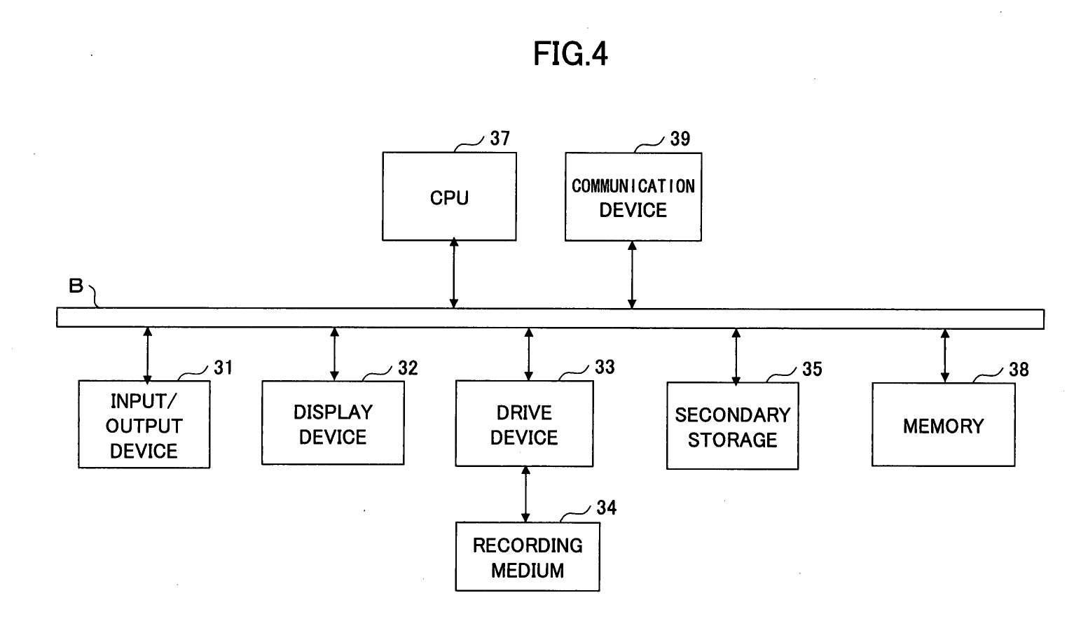

FIG. 4 is a block diagram of a hardware configuration of the server device 301. The server device 301 is a computer including a CPU 37, an input/output device 31, a display device 32, a drive device 33, a memory 38, a secondary storage 35, and a communication device 39.

The input/output device 31 processes various operational signals input by a user with the keyboard unit 102b or a mouse. The input/output device 31 also controls input/output of other input/output devices such as the scanner 302, the IC card reader 311, the printer 104, etc. The display device 32 displays a GUI (Graphical User Interface), such as various windows and data necessary for operating the server device 301, on the display unit 102a. The communication device 39 serves as an interface used for connecting the server device 301 to a network; the communication device 39 can be, for example, a NIC (Network Interface Card) or a modem.

A workflow program for operating the server device 301 can be provided by a recording medium 34 such as a memory card or a CD-ROM, or can be downloaded from the network. The recording medium 34 is inserted in the drive device 33, and data and programs in the recording medium 34 are installed into the secondary storage 35 via the drive device 33.

The secondary storage 35 includes a hard disk device and a storage element, and stores the OS (Operating System), data, programs, necessary files, etc. The workflow program is copied by the CPU 37 from the secondary storage 35, and loaded in the memory 38 to be executed.

The workflow program causes the CPU 37 to function as the electronic form managing unit 303, the electronic flow process unit 304, the workflow engine unit 305, the paper flow process unit 306, the print process unit 111, the form access managing unit 308, and the paper form managing unit 309.

Referring back to FIG. 3, the scanner 302 emits reading light onto an original, and focuses the light reflected from the original onto a solid-state image sensing device. The focused image is converted into digital signals of a predetermined number of bits by performing A/D conversion. An IPP (Image Processing Unit) performs pixel calculation on the digitalized signals of the solid-state image sensing device, such as shading correction, background removal, tone correction, and luminance unevenness correction. Subsequently, the digital signals are transmitted to the server device 301 via the scanner I/F control unit 307. The scanner 302 can be a type used by pressing an original against a platen glass, or a type that photographs an original from above. The solid-state image sensing device can be a one-dimensional image sensing device in which elements are arranged one-dimensionally, or a two-dimensional image sensing device in which elements are arranged two-dimensionally.

The IC card reader 311 reads user authentication information recorded in an IC card in a contact or non-contact manner. The IC card is also called a smart card, which has high tamper resistance, so that internal structures and data stored therein are difficult to analyze. The IC card includes a CPU, which can perform encrypting processes and user authentication; therefore, the IC card functions as an information processing terminal.

The printer 104 prints forms based on image data specified by the printer I/F control unit 112 by using conventional printing methods such as a laser method, an LED method, an inkjet method, etc.

Next, a description is given of operations for preparing (creating) a paper form for workflow processes performed by the server device 301 of the workflow system according to an embodiment of the present invention (step S1).

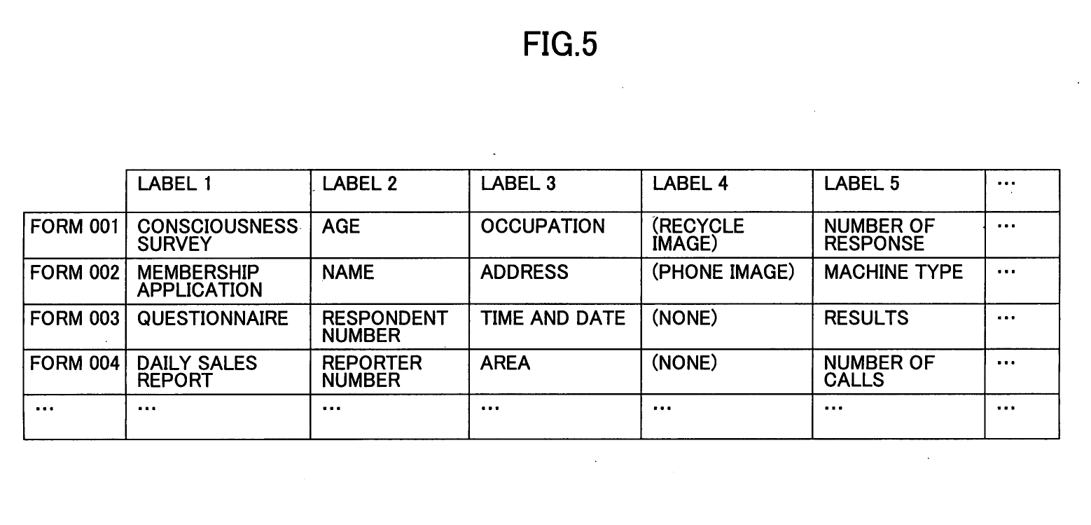

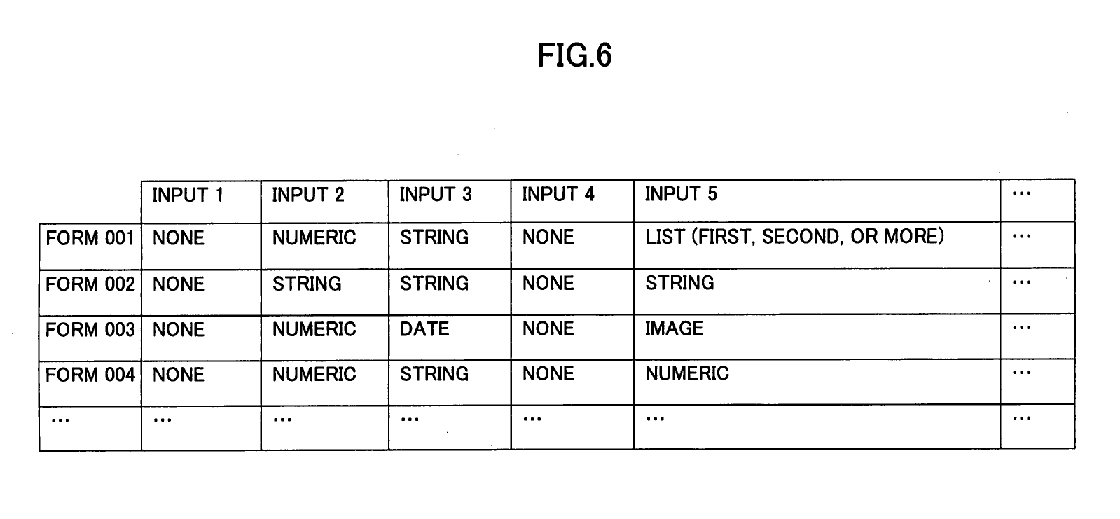

The electronic form managing unit 303 includes a screen formation data table storing screen formation data used for electronically displaying a form used in the workflow, and an input data type table defining input data types corresponding to the data display. FIG. 5 is one example of the screen formation data table, and FIG. 6 is one example of the input data type table.

In the screen formation data table shown in FIG. 5, Form 001 indicates a form of a consciousness survey, Form 002 indicates a form of a membership application, Form 003 indicates a form of a questionnaire, and Form 004 indicates a form of a daily sales report. Labels 1 through 5 indicate label names given for input fields provided for each Label. For example, in Form 1, Label 1 is “consciousness survey”, Label 2 is “age”, Label 3 is “occupation”, Label 4 is “(Recycle image)”, and Label 5 is “number of response”. Accordingly, these characters or images are displayed in predetermined positions near each of the input fields. When a character string is stored in the screen formation data table, the character string is displayed, and when a filename is shown in parenthesis as in Label 4, the contents of the corresponding file are displayed. When an image is to be displayed as in Label 4, the image data themselves can be stored. In Form 2, Label 1 is “membership application”, Label 2 is “name”, Label 3 is “address”, Label 4 is “(Phone image)”, and Label 5 is “machine type”. In Form 3, Label 1 is “questionnaire”, Label 2 is “respondent number”, Label 3 is “time and date”, Label 4 is “(none)”, and Label 5 is “results”. In Form 4, Label 1 is “daily sales report”, Label 2 is “reporter number”, Label 3 is “area”, Label 4 is “(none)”, and Label 5 is “number of calls”.

In the input data type table shown in FIG. 6, Form 001 indicates that Input 1 is “none”, Input 2 is “numeric”, Input 3 is “string”, Input 4 is “none”, and Input 5 is “list (first, second, or more)”. In this table, “none” indicates that the corresponding field is not available for user input, and only displays a label; “numeric” indicates that a value is to be input; “string” indicates that characters are to be input; and “list (first, second, or more)” indicates that first, second, or more will be displayed as choices for selection. Labels 1 through 5 correspond to Inputs 1 through 5, respectively.

In Form 002, Input 1 stores “none”, Input 2 stores “string”, Input 3 stores “string”, Input 4 stores “none”, and Input 5 stores “string”. In Form 003, Input 1 stores “none”, Input 2 stores “numeric”, Input 3 stores “date”, Input 4 stores “none”, and Input 5 stores “image”. In Form 004, Input 1 stores “none”, Input 2 stores “numeric”, Input 3 stores “string”, Input 4 stores “none”, and Input 5 stores “numeric”.

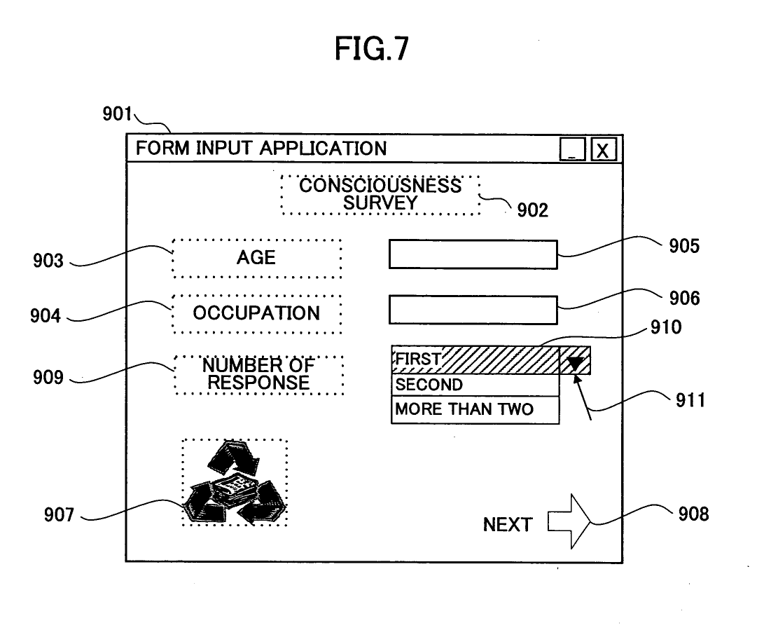

The electronic form managing unit 303 uses the screen formation data table and the input data type table to generate an input screen to be displayed on the display unit 102a. FIG. 7 is an electronic input screen 901 of Form 001 displayed by the electronic form managing unit 303, by using the screen formation data table shown in FIG. 5 and the input data type table shown in FIG. 6. In FIG. 7, “consciousness survey” of Label 1 is displayed in label 902, “age” of Label 2 is displayed in label 903, “occupation” of Label 3 is displayed in label 904, and “number of response” of Label 5 is displayed in label 909.

Rectangular areas available for user input are provided as an input field 905 for age and an input field 906 for occupation, and input data are stored as numeric (value) type data or string (character string) type data.

Label 907 displays the Recycle image stored as Label 4 in the screen formation data table shown in FIG. 5. Label 910 displays a list box for providing a threefold choice corresponding to Input 5. In FIG. 7, a cursor 911 is clicking the list box to show the pull-down menu, so that all items are displayed.

A transition button 908 is provided for moving to the next input screen. When there are items included in the tables shown in FIGS. 5, 6 that cannot fit into a single input screen, the items can be included in a subsequent input screen that can be displayed by pressing the transition button 908. A scroll-bar can be provided at the side of the input screen 901, and items that cannot fit into a single input screen can be displayed by scrolling the screen with the scroll-bar.

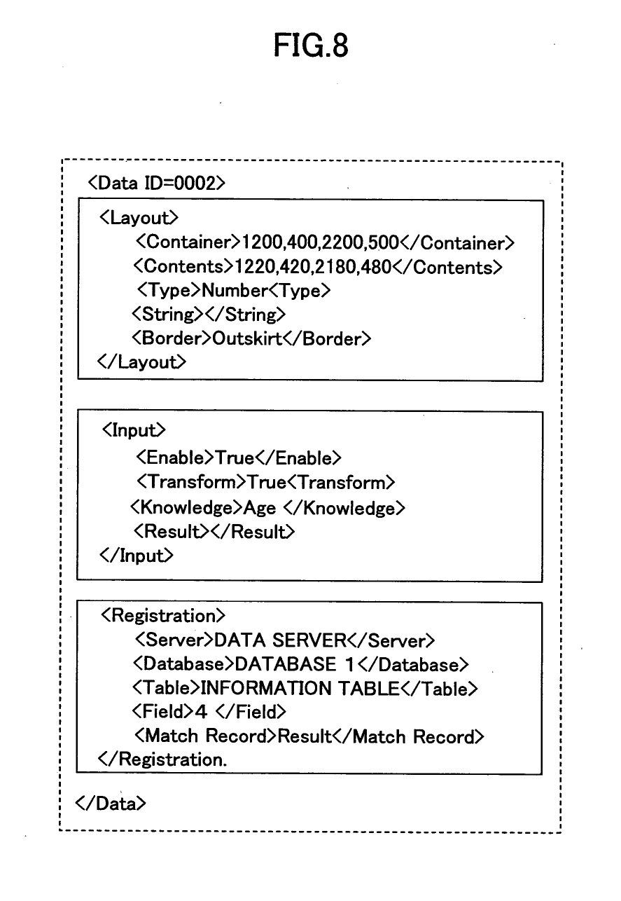

An electronic form can be created by executing a form creating program. The form creating program is used for defining a layout of a form as shown in FIG. 7 and a method of processing a form by a form structure as shown in FIG. 8, and for creating/editing the contents. For example, the form structure shown in FIG. 8 manages the input field 905 by an element label <Layout> for indicating form layout information, an element label <Input> for indicating authentication information, and an element label <Registration> for indicating a destination where data are saved; contents of these labels are described with properties of XML. Another example of an electronic form structure can be in an HTML format to display a Web page with FORM tags including GET, POST methods that are available for user input.

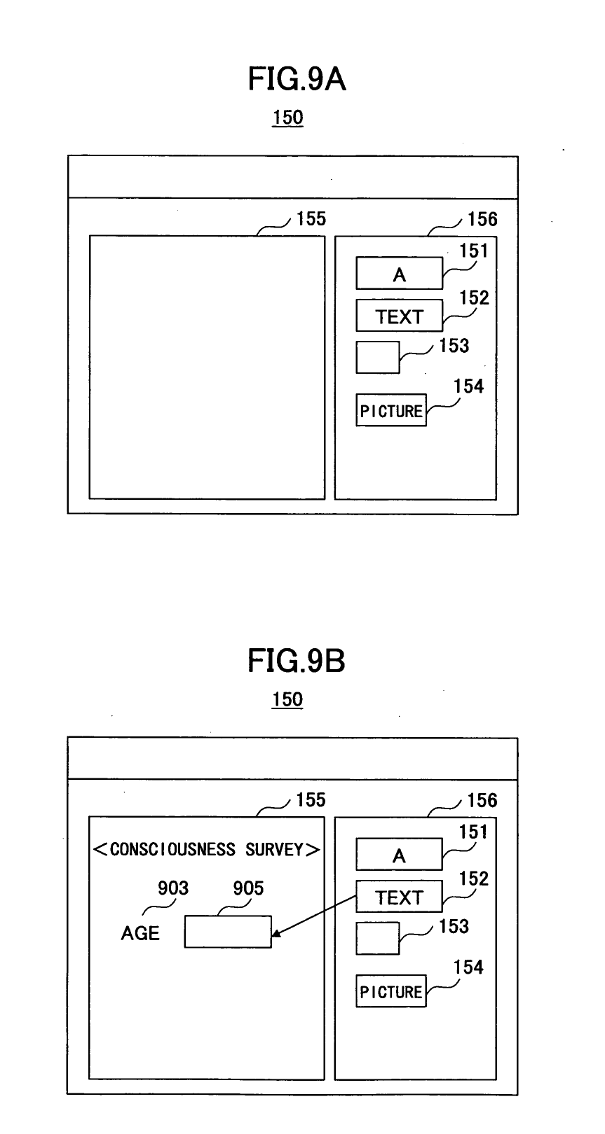

The form creating program has a GUI 150 as shown in FIGS. 9A, 9B. The GUI 150 includes a layout area 155 and a tool box 156. The tool box 156 includes a label tool 151, an input tool 152, a select box 153, and an image input tool 154.

A person creating a form can arrange Label areas and Input areas in the layout area 155 by using the tool box 156. The label tool 151 is used for creating Label 1 (shown in FIG. 5) in the layout area 155. The input tool 152 is used for creating the input fields 905, 906 (shown in FIG. 7) in the layout area 155. The select box 153 is used for creating a select box such as the label 910 (shown in FIG. 7) in the layout area 155. The image input tool 154 is used for pasting image data such as the label 907 (shown in FIG. 7) in the layout area 155.

As described above, a label appropriate for its contents is laid out in the layout area 155 by the tool box 156, and its property is defined on the screen. For example, as shown in FIG. 9B, a field for inputting an age is created by using the input tool 152. The input data type table shown in FIG. 6 is generated from a form file created by the form creating program.

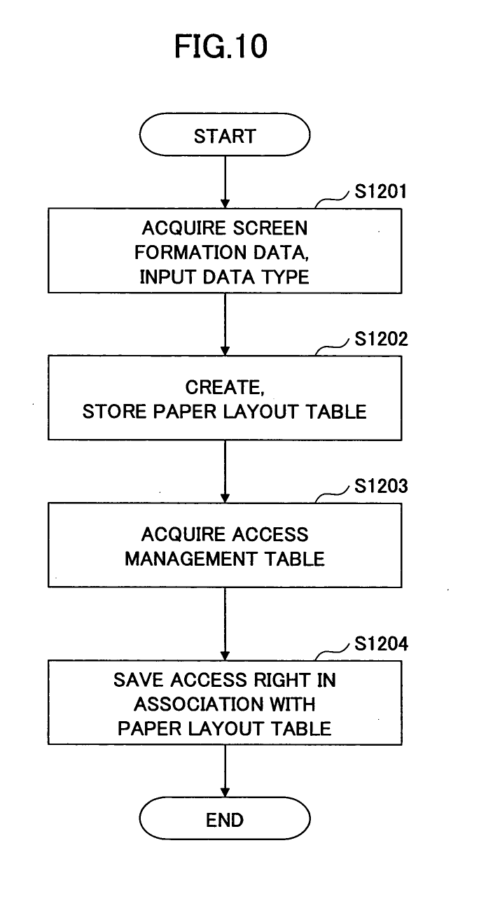

FIG. 10 is a flowchart of a process performed by the paper flow process unit 306 for creating the paper form P based on the structures shown in FIGS. 5, 6. The process of the flowchart shown in FIG. 10 starts when an administrator inputs, e.g., a print instruction in the user interface 102. The print instruction is given for obtaining the paper form P by printing an input screen of an electronic form. The printing operation of the paper form P is not necessary in the workflow for the electronic form; therefore, paper form P is created only when a print instruction is given by an administrator or a user. Accordingly, a process for creating a paper form or storing a created paper form is not performed unless specified, so that an efficient workflow process system can be realized.

The electronic form managing unit 303 acquires data of an electronic form from the screen formation data table shown in FIG. 5 and the input data type table shown in FIG. 6 (step S1201). For example, when Form 001 is designated, each of the labels “consciousness survey”, “age”, “occupation”, image data of the Recycle image, and “number of response”, and input data types for each of these labels are acquired. The acquired information is transmitted to the paper form managing unit 309 via the paper flow process unit 306.

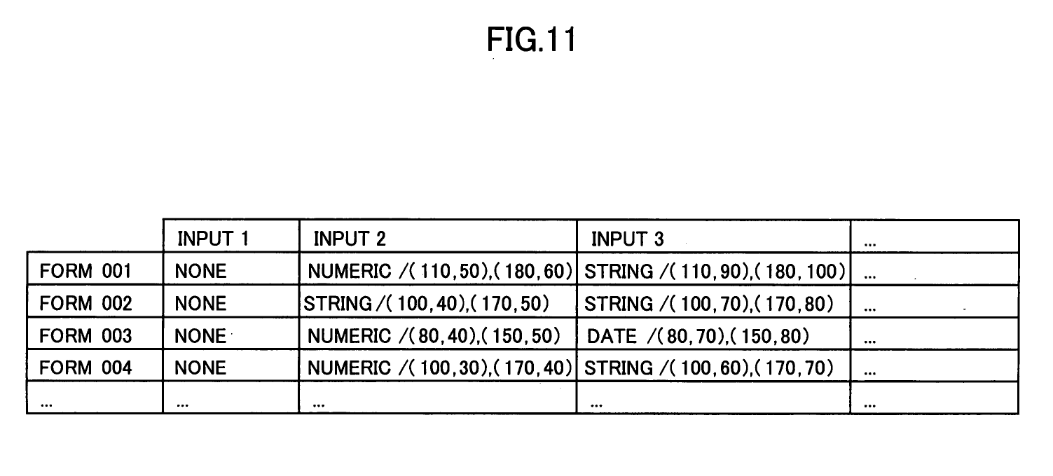

Next, a layout is determined by the paper form managing unit 309 for positioning input fields corresponding to labels on the print-out paper. FIG. 11 is one example of a paper layout table defining a paper layout. The paper layout table includes at least a data type as shown in the input data type table and coordinate information indicating its position on paper. In FIG. 11, a data type and coordinates of diagonal apexes of a rectangular area are specified for Input 1 through 3 in each Form. In addition, a position of a label corresponding to each input field, font, color, size, etc., can be specified. The created paper layout table is stored in the disk device 105. The paper form managing unit 309 generates a document image of a form to be printed on paper, based on the paper layout table (hereinafter, “paper form document”), and stores the paper form document in the disk device 105 (step S1202).

The printed paper form P is described below. The electronic form includes items in input fields that are not always displayed, such as the list box 910. Therefore, the paper form P may not include all items simply by printing the electronic form. Thus, when the paper form P includes an input field whose data type is List, in order to ensure that all contents of the List are shown, the paper flow process unit 306 acquires contents of the List (in Form 001, the contents are first, second, or more) from the paper layout table, and acquires coordinate information. Accordingly, items in an electronic form that are difficult to express in a paper form, such as a list box with a pull-down menu, can be converted to an appropriate format to be shown in a paper form.

Next, the paper form managing unit 309 acquires an access right for the paper form document (step S1203). An access right is associated with a user ID or a group ID managed by the workflow system. The access right defines whether printing of a form, a paper flow process, or an electronic flow process is permitted. The access right is previously stored in the form access managing unit 308.

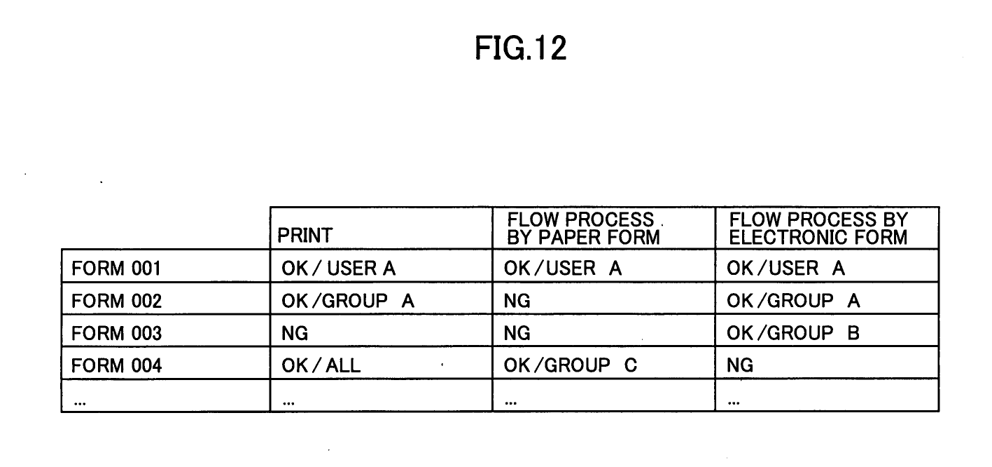

An access management table is described. FIG. 12 is one example of the access management table including access rights managed by the access managing unit 308. The access management table shown in FIG. 12 indicates whether permission (OK) or prevention (NG) is defined for each form regarding operations of printing onto paper, a flow process using a printed paper form P, and a conventional flow process using the electronic form. Further, the access management table shown indicates permission (OK) or prevention (NG) for a user or a group.

In FIG. 12, with regard to FORM 001, all operations of printing onto paper, a flow process using a printed paper form P, and a flow process using the electronic form, are permitted for user A. In FIG. 12, one user or one group is defined in each item; however, plural users or plural groups can be defined.

As described above, an access right can be assigned to each of the operations of printing, controlling a flow process for paper, and controlling a flow process for an electronic form; therefore, each route can be controlled by desired units, such as by user or by group.

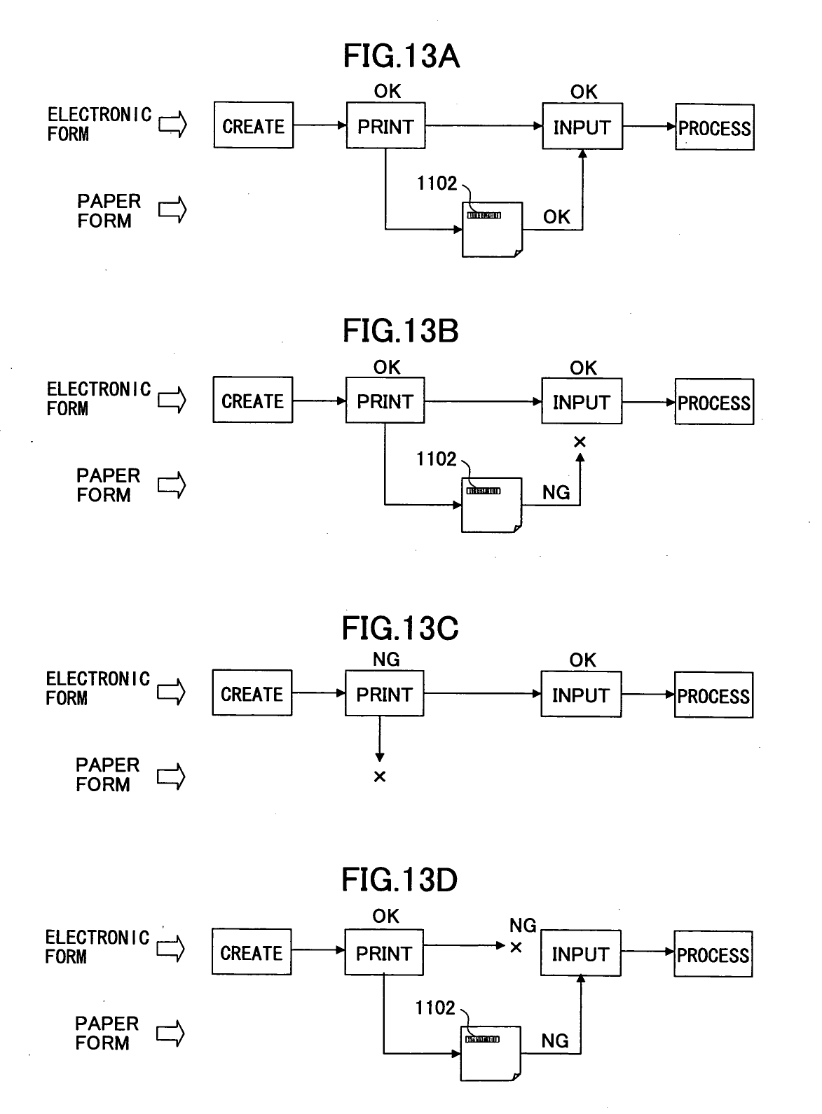

FIGS. 13A, 13B, 13C, 13D are route diagrams of workflow processes controlled according to access rights. Specifications of the access rights are as shown in FIG. 12, and FIG. 13A is a setup for Form 001, FIG. 13B is a setup for Form 002, FIG. 13C is a setup for Form 003, and FIG. 13D is a setup for Form 004. In FIGS. 13A through 13D, it is disregarded as to whether the routes are controlled by units of users or groups.

As shown in FIG. 13A, printing, flow control for paper, and flow control for an electronic form are permitted for Form 001; therefore, content can be input to the Form 001 from an electronic form or a paper form P. In this case, when a particular user inputs content to the Form 001 from either one of an electronic form or a paper form P, the corresponding user is prevented from inputting content from the other route.

As shown in FIG. 13B, printing and flow control for an electronic form are permitted, but flow control for paper is prevented for Form 002; therefore, contents can only be input to the Form 001 from an electronic form. In this case, the electronic form can be printed on paper to be viewed, so that a user can thoroughly study the form before inputting content in the electronic form.

As shown in FIG. 13C, printing and flow control for paper are prevented, and only flow control for an electronic form is permitted for Form 003. Accordingly, information can be prevented from being leaked by paper documents, so that the workflow process is advantageous in terms of security.

As shown in FIG. 13D, printing and flow control for paper are permitted, but flow control for an electronic form is prevented for Form 004. For example, when it is difficult to electronically input modifications to a product design diagram included in the form, it is ineffective to permit the route of an electronic form to users. In this case, it is therefore preferable to permit only flow control for paper.

Accordingly, by introducing a workflow process for paper, it is possible to control the input route according to the characteristics of the form.

An administrator can input setups to the access management table with the keyboard unit 102b while viewing the display unit 102a. The input setups are provided to the form access managing unit 308 via the user I/F control unit 108, the electronic flow process unit 304, and the workflow engine unit 305.

The access management table can be created for each form when creating the form with the form creating program, or the access management table can be directly created through use of an XML document.

In an electronic workflow used on a daily basis, access rights are already specified for a flow process for an electronic form; these access rights specified for the flow process for an electronic form can be applied to a flow process for the paper form P. Accordingly, when a workflow for an electronic form already exists, the access management table for the electronic form can be automatically used as a default access management table for the paper form P. By designating the access management table for the paper form P in this manner, the paper form P can be introduced with the same access setups as that of the electronic form.

Preliminary operations for a flow process for the paper form P, such as step S2 shown in FIG. 2, can be performed when an electronic form is created, or when printing the form onto paper.

When an access right is acquired, the paper form managing unit 309 saves the access right in association with the paper layout table in the form access managing unit 308 (step S1204). Accordingly, the paper layout table and the paper form document are created for the workflow process for the paper form P.

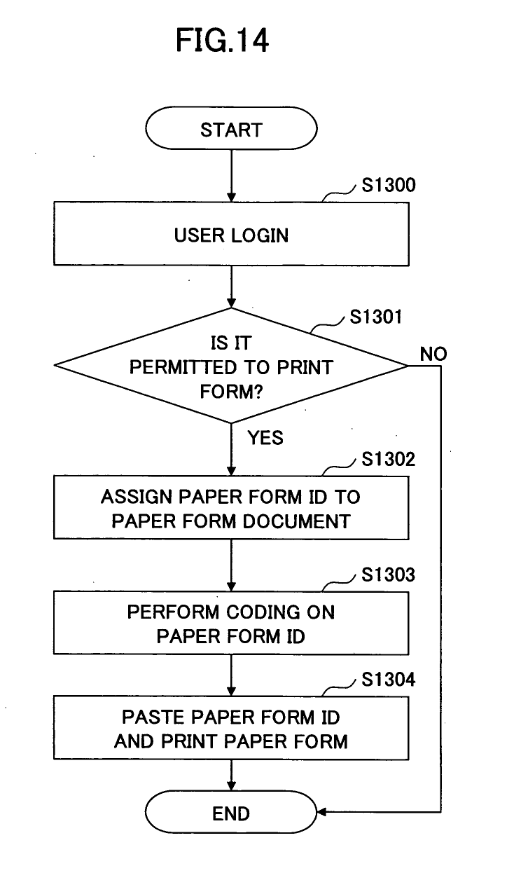

Next, the operation of printing the paper form P of the workflow system (step S2) is described in detail. FIG. 14 is a flowchart of a process performed by the paper flow process unit 306 for printing the paper form P.

First, user A uses the user interface 102 to log into the server device 301 (step S1300). The server device 301 reads user authentication information from an IC card, and verifies whether the user authentication information matches a password or biometric information input from the user; when verified, the server device 301 authenticates the user, and permits the user to log in.

When user A desires to print the Form 001, the paper flow process unit 306 determines whether it is permitted to print the Form 001 by referring to the access management table in the form access managing unit 308 via the workflow engine unit 305 (step S1301). Specifically, the workflow engine unit 305 refers to the access management table shown in FIG. 12 held in the form access managing unit 308 to determine whether the user A is permitted (OK) to print the Form 001. When printing is not permitted, an error message, etc., is displayed, and the process ends.

When printing is permitted, the paper flow process unit 306 assigns a paper form ID to the paper form document, and registers the paper form ID in the paper form managing unit 309 (step S1302).

The paper form ID includes an identification ID of the electronic form (Form 001 in this example), a unique serial number if the same form is printed plural times, and the total number of pages to be printed.

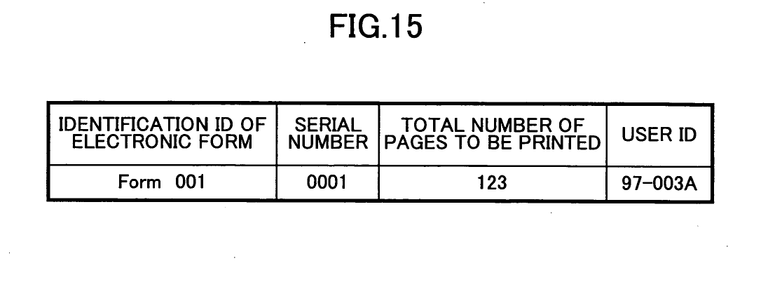

The paper form ID preferably includes a user ID for identifying the user who requested the printing of the paper form P. Accordingly, as shown in FIG. 15, the paper form ID includes an identification ID of the electronic form, a serial number, the total number of pages to be printed, and a user ID.

The paper form ID includes a unique serial number for each print-out. Therefore, when the user ID and the serial number are verified, the paper form P is printed for user A. Further, when the paper form P is input to a scanner after handwritten information is added by user A, the information can be authenticated as being handwritten by user A. Accordingly, an identification ID of the electronic form, a serial number, the total number of pages to be printed, and a user ID are stored in the paper form managing unit 309 in association with each other, as shown in FIG. 15.

The paper flow process unit 306 performs imaging (coding) on the paper form ID (including the user ID), and pastes the code on the paper form document (step S1303). The code can be in any format such as a one-dimensional barcode or a two-dimensional barcode. Further, information can be written into an IC tag embedded in a paper sheet, or an IC tag can be pasted onto a paper sheet.

When a position on the paper form P has been specified, the coded paper form ID is pasted onto the specified position; and when a position has not been specified, the coded paper form ID is pasted onto a predetermined position on the paper form P.

The coded paper form ID is pasted by using, for example, a pasting function of display software (word processing software) of the electronic form. A program in a COM format of Windows® can call a pasting module from macro functions of the display software, and by using an AddPicture method of a module called WordObjectLibrary, an image can be inserted at an arbitrary position in an electronic document. Accordingly, the paper form P to be printed is provided with a coded paper form ID.

Next, the print process unit 111 instructs the printer 104 to print the paper form P via the printer I/F control unit 112 (step S1304).

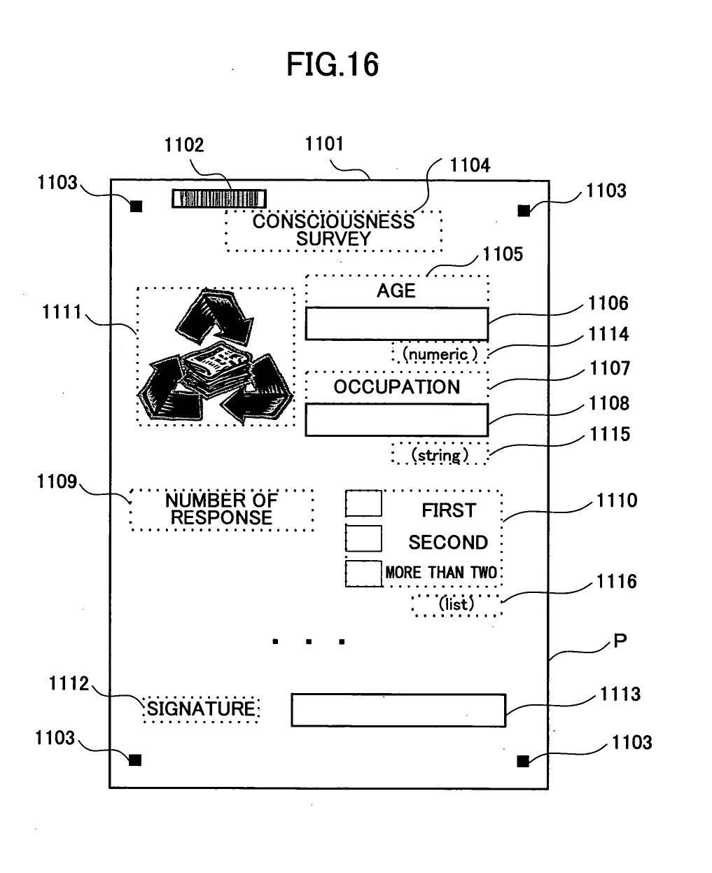

FIG. 16 is an example of the Form 001 printed onto paper by the printer 104. Black rectangles located in the four corners of the paper form are markers used for correcting distortion of a scanned image of the paper form. The print process unit 111 automatically prints these rectangles when printing the paper form P.

The barcode (paper form ID) 1102 is a coded version of the paper form ID, which is a one-dimensional barcode in this example.

Labels 1104, 1105, 1107, and 1109 correspond to the labels 902, 903, 904, and 909 shown in FIG. 7, respectively. The image 1111 corresponds to the Recycle image specified in Label 4 of the screen formation data table shown in FIG. 5.

Input fields 1106, 1108, and 1110 correspond to the labels 905, 906, and 910 shown in FIG. 7, respectively. Respondents of the survey handwrite their responses into the rectangular areas 1106, 1108, and 1110.

The data types for the input fields 1106, 1108, 1110 are extracted from the paper layout table shown in FIG. 11, and are printed on the periphery of each of the input fields. Specifically, the data type “numeric” 1114 is printed at the input field 1106 for age, the data type “string” 1115 is printed at the input field 1108 for occupation, and the data type “list” 1116 is printed at the input field 1110 for number of response.

Accordingly, the data format of the response to be input in each input field is made clear to the respondent (user A), so as to induce an appropriate input.

As described in the paper layout table, the label 910 is a pull-down menu in the electronic form, but all choices are listed to be seen in the paper form.

The paper form P includes a “signature” label 1112, which indicates that a signature is to be written in a rectangular area serving as an input field 1113. The input field 1113 and the indication of “signature” are not stored in the paper form document. These items can be automatically printed by the print process unit 111 when printing the paper form P, or a pasting function of display software (word processing software) can be used as in the case of the coded paper form ID. The user can instruct whether to print these items at the user interface 102, so as not to print them when a signature is unnecessary.

Authentication of the signature is performed by comparing a previously stored image of a reference signature of the user with an input image of the paper form P. For example, when characteristic points such as intersection points of characters and positions of points, or lengths of characters match by a predetermined ratio, the user is authenticated. In order to prevent forgery committed by using a copy of the signature, when the signatures match completely, the user is not authenticated.

Accordingly, by providing a signature field, it is possible to identify the user who has filled out the form as the user who has signed the form. For example, when a different user B has written in and signed the form, but the user A scans the form, the signature differs from that of the user A. In this case, the written contents are treated accordingly, such as excluding them from statistics.

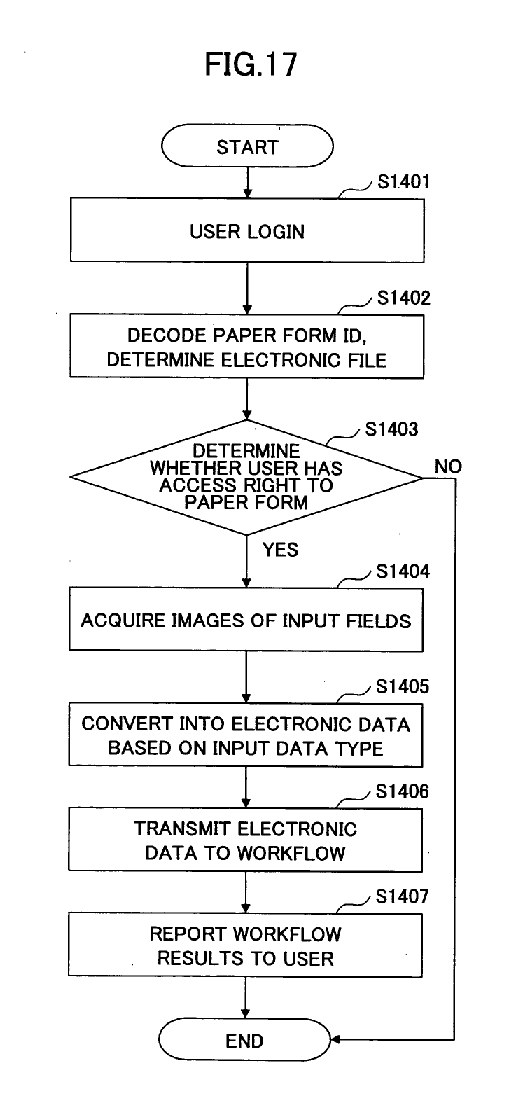

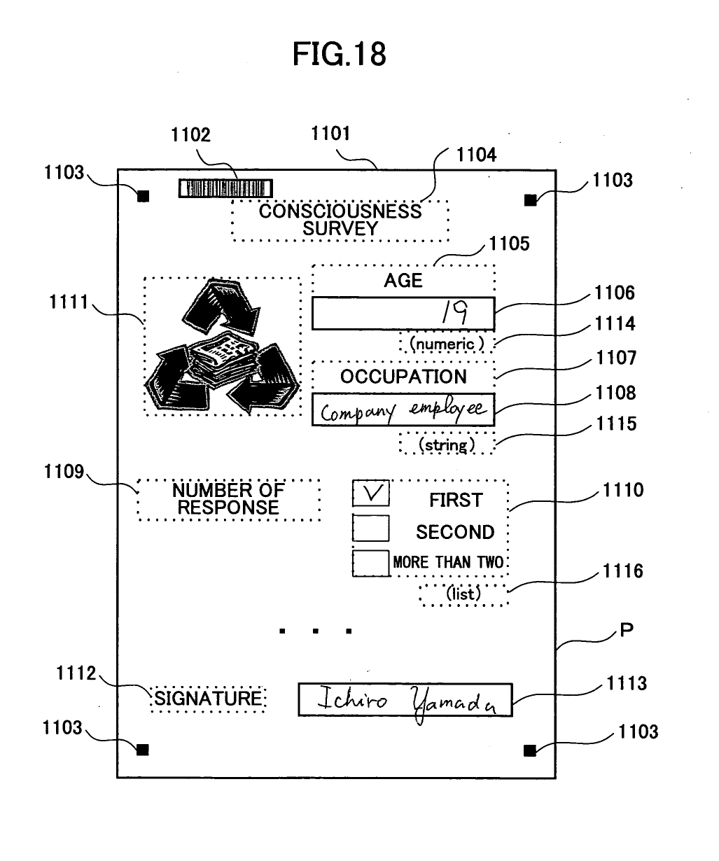

Next, a description is given of a flow process (step S4) performed after the respondent has filled out the printed paper form P (step S3). FIG. 17 is a flowchart of a workflow process operation performed by the paper flow process unit 306, and FIG. 18 is an example of the paper form P with handwritten contents. The user uses the user interface 102 to log into the server device 301 (step S1401). The server device 301 reads user authentication information from an IC card, and verifies whether the user authentication information matches a password or biometric information input from the user; when verified, the server device 301 authenticates the user, and permits the user to log in. In this example, the server device 301 performs user authentication by controlling an IC card inserted into the IC card reader 311 via the card I/F control unit 310. Accordingly, user information can be acquired. By authenticating the user, it is possible to identify the person who has written on the paper form P.

When the form includes the input field 1113 for a signature, the user authentication can be performed by extracting the area corresponding to the input field 1113, verifying whether the extracted signature matches previously saved handwriting of the user, and acquiring user information.

Next, the paper flow process unit 306 fetches an image of the paper form P set in the scanner 302 via the scanner I/F control unit 307, reads the coded paper form ID 1102 from the image, decodes the coded paper form ID 1102, and acquires the paper form ID 1102 (step S1402). In the workflow system according to an embodiment of the present invention, the paper form ID is registered in the paper form managing unit 309 when the paper form ID is printed. Therefore, based on the decoded paper form ID, it is possible to determine that the form of Form 001 has been scanned.

When it is determined that the form is Form 001, the paper flow process unit 306 can determine whether the user has the right to access this paper form P, based on the access management table shown in FIG. 12 (step S1403). When the user is not permitted to access the paper form P, the process shown in FIG. 17 ends.

When the user is permitted to access the paper form P, the paper flow process unit 306 extracts layout information from the paper layout table, which table corresponds to the acquired paper form ID (step S1404). The paper flow process unit 306 reads coordinates of rectangular areas serving as input fields of the paper for P from the extracted paper layout information, and acquires images of the input fields (in the example shown in FIG. 16, the input fields 1106, 1108, 1110, and 1113) (step S1404).

The images of the input fields can be acquired according to a difference between the electronic form and the image of the paper form P input by the scanner 302. Specifically, the paper flow process unit 306 performs a pattern matching process, in which an image of the electronic form is specified as a reference pattern with respect to an image of the input paper form P. A correlation coefficient of luminance is obtained for each pixel. When maximum correlation is obtained, the image of the paper form P is masked with the reference pattern, so as to acquire the images of the handwritten contents of the input fields.

The images of the input fields acquired in step S1404 are converted into electronic data of corresponding data types (step S1405). The data type of each of the input fields can be detected from the paper layout table shown in FIG. 11. When the data types are detected, the paper flow process unit 306 performs an OCR process so as to adapt the images of the input fields to the respective data types, thereby converting the images into electronic data.

The paper flow process unit 306 transmits the electronic data obtained in step S1405 to the workflow engine unit 305, so that the workflow process can be executed (step S1406) (step S5). For example, in the case of Form 001, which is used for a consciousness survey, processes are performed to obtain statistics such as an age distribution of respondents.

The workflow engine unit 305 reports results of the workflow process to the user (step S1407). Theses results can be displayed on the display unit 102a via the user I/F control unit 108, or sent by e-mail to a previously saved e-mail address of the user. The e-mail address is saved in the form access managing unit 308. Thus, a user who is unfamiliar with a workflow process including the paper form P can feel safe in using the workflow system.

Contents reported to the user can simply indicate whether the workflow process has been appropriately completed, or include the scanned image data and electronic handwritten information obtained by the OCR process presented together. The report can be configured to include the scanned image data and electronic handwritten information obtained by the OCR process presented together only when the OCR process has been performed at an uncertainty level greater than or equal to a predetermined threshold.

As described above, in the workflow system according to an embodiment of the present invention, an electronic form used in processes of a workflow can be printed onto paper, and the printed-out paper form can be used for the processes of the workflow.

[Modifications]

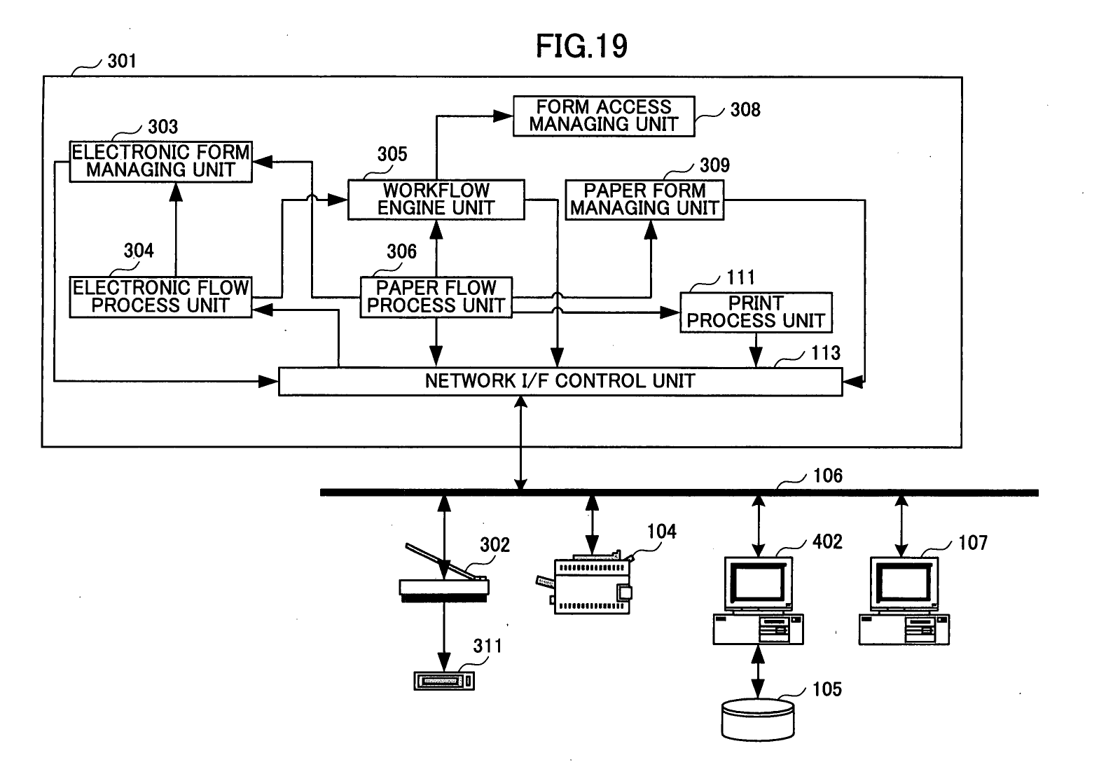

The workflow system according to an embodiment of the present invention is not limited to the configuration of the functional block diagram shown in FIG. 3. FIG. 19 is a functional block diagram of another embodiment of the workflow system. In FIG. 19, elements corresponding to those in FIG. 3 are denoted by the same reference numbers, and are not further described.

In the workflow system shown in FIG. 19, the scanner 302, the printer 104, a storage server device 402, and the client device 107 are connected to the server device 301 via the network 106. The scanner 302 includes the IC card reader 311, and the storage server device 402 includes the disk device 105. The scanner 302 and the printer 104 are connected via the network 106, and therefore correspond to a network scanner and a network printer, respectively. However, the functions of the scanner 302 and the printer 104 are the same as those shown in FIG. 3.

The electronic flow process unit 304 of the server device 301 is connected to the network 106 via the network I/F control unit 113, and controls user operations input from the client device 107 and output to the client device 107. User input from the network 106 is sent to the workflow engine unit 305, and electronically created screen formation data of an electronic form are stored in the disk device 105 of the storage server device 402 via the network I/F control unit 113 and the network 106.

The paper form managing unit 309 creates a paper layout table including design data of a paper form based on the electronically created screen formation data. The paper layout table is also stored in the disk device 105 of the storage server device 402 via the network I/F control unit 113 and the network 106. In response to a user's request, an image is generated based on the stored paper layout table at the print process unit 111, and then printed at the printer 104 via the network I/F control unit 113 and the network 106.

The electronic flow process unit 304 performs processes on content input by a user from the client device 107, which is received via the network I/F control unit 113 and the network 106. The electronic flow process unit 304 then transmits the content to the workflow engine unit 305, so that the workflow process is executed. In another example, the paper flow process unit 306 performs processes on data and user authentication information input by a user from the scanner 302, which are received via the network I/F control unit 113 and the network 106. The paper flow process unit 306 then transmits the data and the user authentication information to the workflow engine unit 305, so that the workflow process is executed. The form access managing unit 308 manages access rights for each user to perform printing, paper flow processes, and electronic flow processes.

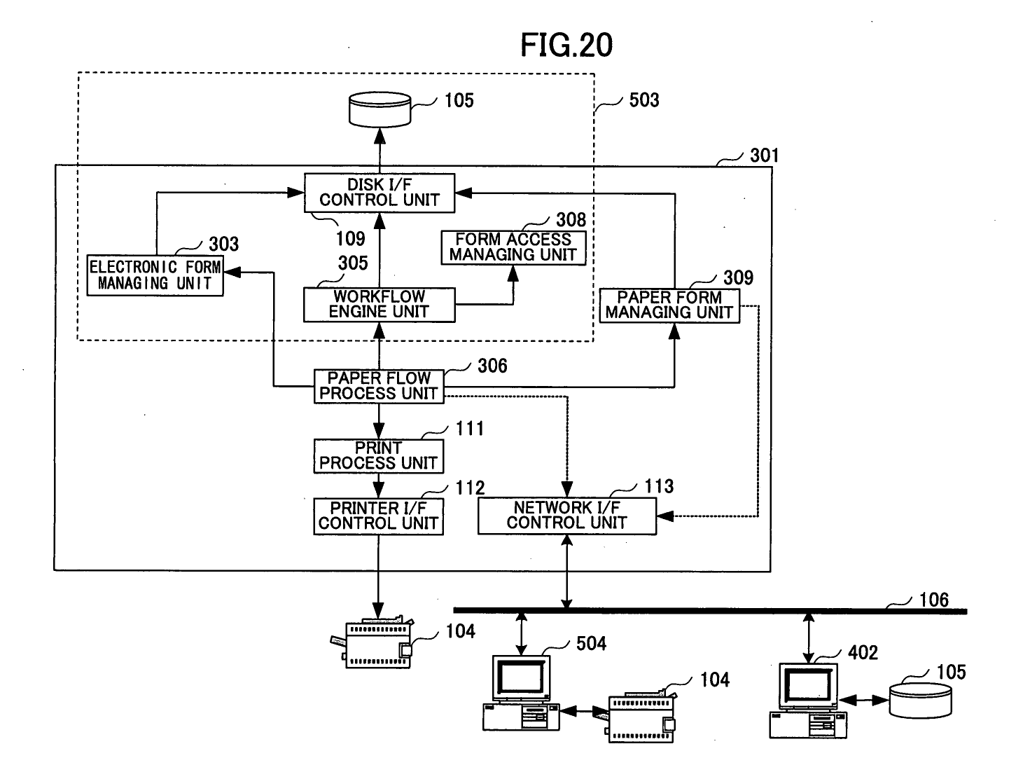

FIG. 20 is a functional block diagram of still another embodiment of the workflow system. In FIG. 20, elements corresponding to those in FIG. 3 are denoted by the same reference numbers, and are not further described. In the workflow system according to an embodiment of the present invention, the functions do not need to be included entirely in the server device 301; the functions can be distributed across another computer connected to the network.

As shown in FIG. 20, a computer 504 is connected to the network 106, and elements enclosed by a dashed line 503 are included in the computer 504. Specifically, the elements are the electronic form managing unit 303, the disk I/F control unit 109, the workflow engine unit 305, the form access managing unit 308, and the disk device 105.

In the server device 301, the paper flow process unit 306 receives a print request from a user via the network I/F control unit 113 and the network 106. The print request is transmitted via the network 106 to the workflow engine unit 305 of the computer 504. The workflow engine unit 305 creates a paper layout table based on screen formation data, and stores the paper layout table in the disk device 105 via the disk I/F control unit 109.

In response to a user's request, the stored paper layout table is transmitted to the server device 301, and is printed at the printer 104 via the print process unit 111 and the printer I/F control unit 112. The form access managing unit 308 manages access rights for each user to perform printing, paper flow processes, and electronic flow processes.

When the storage server device 402 including the disk device 105 is connected to the network 106 as shown in FIG. 20, the computer 504 does not need to include the disk I/F control unit 109 or the disk device 105. In this manner, the functions of the workflow system according to an embodiment of the present invention can be distributed across multiple elements.

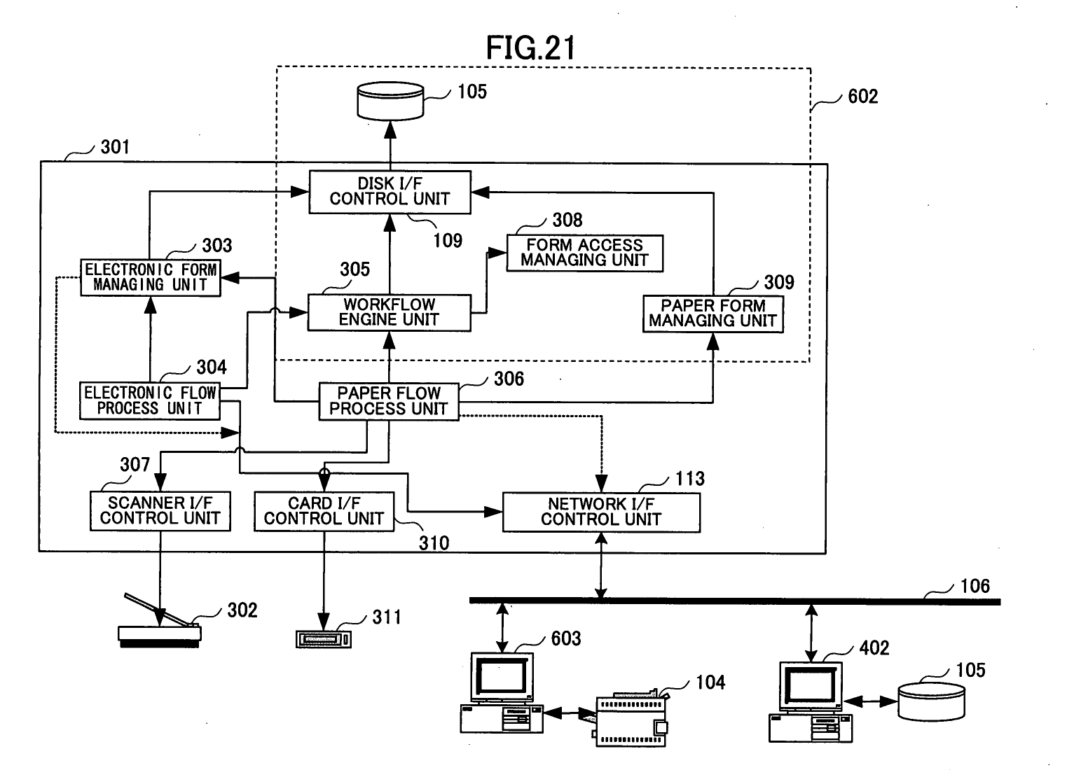

FIG. 21 is a functional block diagram of still another embodiment of the workflow system. In FIG. 21, elements corresponding to those in FIG. 3 are denoted by the same reference numbers, and are not further described. In the workflow system shown in FIG. 21, the functions of the workflow system are distributed across another computer 603, and elements enclosed by a dashed line 602 are included in the computer 603.

The server device 301 is connectable to the scanner 302 and the IC card reader 311. The electronic flow process unit 304 of the server device 301 controls user input/output via the network I/F control unit 113 and the network 106.

Content input by a user via the network 106 is transmitted to the workflow engine unit 305 of the computer 603, and screen formation data are stored in the disk device 105 via the disk I/F control unit 109. The paper form managing unit 309 creates a paper layout table for a paper form based on screen formation data. The paper layout table is also stored in the disk device 105 via the disk I/F control unit 109.

The electronic flow process unit 304 performs processes on data input by a user from the client device 107, which are received via the network I/F control unit 113 and the network 106. The electronic flow process unit 304 then transmits the contents to the workflow engine unit 305, so that the workflow process is executed. In another example, the paper flow process unit 306 performs processes on scanned image data input by a user, which are received via the network I/F control unit 113 and the network 106. The paper flow process unit 306 then transmits user authentication information acquired from the IC card reader 311 to the workflow engine unit 305 of the computer 603, so that the workflow process is executed.

The form access managing unit 308 of the computer 603 manages access rights for each user to perform printing, paper flow processes, and electronic flow processes. In FIG. 21, the storage server device 402 is connected to the network 106, and therefore, the computer 603 does not need to include the disk I/F control unit 109 or the disk device 105.

Processing units in the above embodiments are described as constituents associated with the claims; however, names of the processing units are given as a matter of convenience, and the constituents are not limited thereto, as long as processes of embodiments according to the present invention can be performed in the workflow system as a whole.

According to an embodiment of the present invention, a workflow system and a server device include paper screen formation data used for printing an input screen of an electronic form, and handwritten information can be associated with the electronic form by a form ID; therefore, a workflow system that can process handwritten content can be provided. Further, a paper form P is printed or processed only when an instruction to print a form is given, and therefore, an efficient workflow system is provided. Moreover, even when an input image of an electronic form includes a list box that does not show all choice items, all of the choice items can be printed on a paper form P, so that the electronic form and the paper form P are accurately consistent. Further, in a paper form P, a data type to be input in an input field is printed near the corresponding input field, so as to induce a user to write in appropriate contents. Moreover, an access right is assigned to a paper form P, to prevent printing, for example, so that a workflow process of handwriting content in the paper form P can be controlled, thereby ensuring security. Further, an access right is assigned both for a paper form P flow process and an electronic form flow process, and therefore, routes of a workflow process can be controlled according to the contents of the workflow, and/or by users/groups, so as to provide a high level of freedom in design of a workflow system. Moreover, an identification ID of a paper form includes a user ID of a user to whom the paper form is distributed (or who fills out the paper form), and therefore, it is possible to determine whether a user has a right to input an image of the paper form. Further, access rights assigned in an electronic form workflow process can be used as access rights for a paper form P workflow process, and therefore, access rights for the paper form P workflow process can be easily determined. Moreover, a signature field, which is not provided in an electronic form, can be provided in a paper form P, so that a user's handwriting can be used for user authentication, thereby facilitating user authentication in a paper form P flow process. Further, when content is handwritten into a paper form P, a report is sent to a user as to whether a workflow process has been successfully completed, and therefore, a user who is unfamiliar with a workflow process including the paper form P can feel safe in using the workflow system.

The present invention is not limited to the specifically disclosed embodiment, and variations and modifications may be made without departing from the scope of the present invention.

The present application is based on Japanese Priority Patent Application No. 2005-278305, filed on Sep. 26, 2005, the entire contents of which are hereby incorporated by reference.

What is claimed is:

1. A workflow system for performing a predetermined process according to information input to an electronic form from an input screen displaying the electronic form, the input screen being formed based on screen formation data, and inputting handwritten information of a corresponding paper form to the electronic form, the workflow system comprising:
a paper form managing unit configured to generate, based on the screen formation data, paper layout information defining the paper form corresponding to the input screen;
a print process unit configured to print the paper form based on the paper layout information together with a form ID identifying the electronic form;
an image input device configured to input an image of the printed paper form to which the handwritten information is added; and
a paper flow process unit configured to extract the handwritten information from the image of the paper form input by the image input device, together with the form ID identifying the electronic form; wherein
the extracted handwritten information is converted to electronic handwritten information, and the electronic handwritten information is input to the electronic form corresponding to the form ID extracted by the paper flow process unit.

2. The workflow system according to claim 1, wherein
the paper form managing unit generates the paper layout information in response to receiving an instruction to print the paper form corresponding to the input screen.

3. The workflow system according to claim 1, wherein
the paper form managing unit generates the paper layout information such that the paper form includes data of the screen formation data that is not always displayed on the input screen.

4. The workflow system according to claim 1, wherein
the screen formation data include data type information indicating a data type appropriate for an input field of the input screen,
the paper layout information includes the data type for the input field, and
the print process unit prints the data type near the input field on the paper form.

5. The workflow system according to claim 1, further comprising:
a user authenticating unit configured to authenticate a user;
an access right management table configured to store access rights in association with the electronic form, the access rights being provided for printing the paper form, accessing the electronic form, and inputting the paper form; and
a form access managing unit configured to determine a permission status based on the access right management table and the form ID, in response to the image input device inputting the image of the printed paper form; wherein
the permission status indicates whether the user authenticated by the user authenticating unit is permitted to one of printing the paper form, accessing the electronic form, and inputting the paper form.

6. The workflow system according to claim 1, wherein the form ID includes a user ID identifying a user permitted to input handwritten content to the paper form, the workflow system further comprising:
a user authenticating unit configured to authenticate a user; and
a form access managing unit configured to determine a permission status based on the form ID, in response to the image input device inputting the image of the printed paper form; wherein
the permission status indicates whether the user authenticated by the user authenticating unit is permitted to input the paper form.

7. The workflow system according to claim 1, wherein, when the image of the printed paper form including the handwritten information is input, a notice is sent to a user to report whether the handwritten information extracted by the paper flow process unit is input to the electronic form corresponding to the form ID extracted by the paper flow process unit.

8. A server device of a workflow system for performing a predetermined process according to information input to an electronic form from an input screen displaying the electronic form, the input screen being formed based on screen formation data, and inputting handwritten information of a corresponding paper form to the electronic form, the workflow system comprising:
a paper form managing unit configured to generate, based on the screen formation data, paper layout information defining the paper form corresponding to the input screen;
a print process unit configured to print the paper form based on the paper layout information together with a form ID identifying the electronic form; and
a paper flow process unit configured to extract the handwritten information from an image of the paper form to which the handwritten information is added, together with the form ID identifying the electronic form, the image being input from an input device; wherein
the extracted handwritten information is converted to electronic handwritten information, and the electronic handwritten information is input to the electronic form corresponding to the form ID extracted by the paper flow process unit.

9. The server device of the workflow system according to claim 8, wherein
the paper form managing unit generates the paper layout information in response to receiving an instruction to print the paper form corresponding to the input screen.

10. The server device of the workflow system according to claim 8, wherein
the paper form managing unit generates the paper layout information such that the paper form includes data of the screen formation data that is not always displayed on the input screen.

11. The server device of the workflow system according to claim 8, wherein
the screen formation data include data type information indicating a data type appropriate for an input field of the input screen,
the paper layout information includes the data type for the input field, and
the print process unit prints the data type near the input field on the paper form.

12. The server device of the workflow system according to claim 8, further comprising:
a user authenticating unit configured to authenticate a user;
an access right management table configured to store access rights in association with the electronic form, the access rights being provided for printing the paper form, accessing the electronic form, and inputting the paper form; and
a form access managing unit configured to determine a permission status based on the access right management table and the form ID, in response to the input device inputting the image of the printed paper form; wherein
the permission status indicates whether the user authenticated by the user authenticating unit is permitted to one of printing the paper form, accessing the electronic form, and inputting the paper form.

13. The server device of the workflow system according to claim 8, wherein the form ID includes a user ID identifying a user permitted to input handwritten content to the paper form, the workflow system further comprising:
a user authenticating unit configured to authenticate a user; and
a form access managing unit configured to determine a permission status based on the form ID, in response to the input device inputting the image of the printed paper form; wherein
the permission status indicates whether the user authenticated by the user authenticating unit is permitted to input the paper form.

14. The server device of the workflow system according to claim 8, wherein, when the image of the printed paper form including the handwritten information is input, a notice is sent to a user to report whether the handwritten information extracted by the paper flow process unit is input to the electronic form corresponding to the form ID extracted by the paper flow process unit.

15. A method of a workflow system for performing a predetermined process according to information input to an electronic form from an input screen displaying the electronic form, and inputting handwritten information of a corresponding paper form to the electronic form, the method comprising the steps of:
(a) generating, based on screen formation data used for forming the input screen, paper layout information defining the paper form corresponding to the input screen;
(b) printing the paper form based on the paper layout information together with a form ID identifying the electronic form;
(c) inputting an image of the printed paper form to which the handwritten information is added;
(d) extracting the handwritten information from the image of the paper form input at step (c), together with the form ID identifying the electronic form; and
(e) converting the extracted handwritten information to electronic handwritten information, and inputting the electronic handwritten information to the electronic form corresponding to the form ID extracted by the paper flow process unit.

16. The method of the workflow system according to claim 15, wherein
the step (a) includes generating the paper layout information such that the paper form includes data of the screen formation data that is not always displayed on the input screen.

17. The method of the workflow system according to claim 15, wherein
the screen formation data include data type information indicating a data type appropriate for an input field of the input screen,
the paper layout information includes the data type for the input field, and
the step (b) includes printing the data type near the input field on the paper form.

18. The method of the workflow system according to claim 15, further comprising the steps of:
(f) authenticating a user;
(g) determining a permission status by referring to an access right management table and based on the form ID, in response to the image of the printed paper form being input at the step (c), wherein
the access right management table stores access rights in association with the electronic form, the access rights being provided for printing of the paper form, accessing the electronic form, and inputting the paper form, and
the permission status indicates whether the user authenticated at the step (f) is permitted to one of printing the paper form, accessing the electronic form, and inputting the paper form.

19. The method of the workflow system according to claim 15, wherein the form ID includes a user ID identifying a user permitted to input handwritten content to the paper form, the method further comprising the steps of:
(f) authenticating a user;
(h) determining a permission status based on the form ID, in response to the image of the printed paper form being input at the step (c), wherein
the permission status indicates whether the user authenticated at the step (f) is permitted to input the paper form.
